(19) United States
(12) Patent Application Publication
(10) Pub. No.: US 2011/0249744 A1
(43) Pub. Date: Oct. 13, 2011

(54) Method and System for Video Processing Utilizing N Scalar Cores and a Single Vector Core

(76) Inventor: Neil Bailey, Cambridge (GB)

(21) Appl. No.: 12/977,483

(22) Filed: Dec. 23, 2010

Related U.S. Application Data
(60) Provisional application No. 61/323,078, filed on Apr. 12, 2010.

(51) Int. Cl. H04N 7/26

(52) U.S. Cl. 375/240.16; 375/E07.125

(57) ABSTRACT

A multimedia processor may comprise a first scalar core, a second scalar core, and a vector core integrated on a single substrate of said multimedia processor. The multimedia processor may receive data and instructions associated with image processing. The multimedia processor may configure the received data and instructions into data and instructions associated with a first image processing program and into data and instructions associated with a second image processing program independent of the first image processing program. The first image processing program may be configured to be handled by the first scalar core and the vector core, while the data and instructions associated with the second image processing program may be configured to be handled by the second scalar core and the vector core. The vector core may communicate data to and from register files in each of the first and second scalar cores.

### CROSS-REFERENCE TO RELATED APPLICATIONS/INCORPORATION BY REFERENCE

This application makes reference to, claims priority to, and claims benefit of U.S. Provisional Application Ser. No. 61/323,078, filed Apr. 12, 2010.

This application also makes reference to:

U.S. patent application Ser. No. 12/795,170 (Attorney Docket Number 21160US02) which was filed on Jun. 7, 2010;
U.S. patent application Ser. No. 12/686,800 (Attorney Docket Number 21161 US02) which was filed on Jan. 13, 2010;
U.S. patent application Ser. No. 12/953,128 (Attorney Docket Number 21162US02) which was filed on Nov. 23, 2010;
U.S. patent application Ser. No. 12/868,192 (Attorney Docket Number 21163US02) which was filed on Aug. 25, 2010;
U.S. patent application Ser. No. 12/953,739 (Attorney Docket Number 21164US02) which was filed on Nov. 24, 2010;
U.S. patent application Ser. No. ______(Attorney Docket Number 21165US02) which was filed on ______;
U.S. patent application Ser. No. 12/942,626 (Attorney Docket Number 21166US02) which was filed on Nov. 9, 2010;
U.S. patent application Ser. No. 12/953,756 (Attorney Docket Number 21172US02) which was filed on Nov. 24, 2010;
U.S. patent application Ser. No. 12/869,900 (Attorney Docket Number 21176US02) which was filed on Aug. 27, 2010; and
U.S. patent application Ser. No. 12/835,522 (Attorney Docket Number 21178US02) which was filed on Jul. 13, 2010.

Each of the above stated applications is hereby incorporated herein by reference in its entirety.

### FIELD OF THE INVENTION

Certain embodiments of the invention relate to communication devices that capture video. More specifically, certain embodiments of the invention relate to video processing utilizing a plurality of scalar cores and a single vector core.

### BACKGROUND OF THE INVENTION

Image and video capabilities may be incorporated into a wide range of devices such as, for example, cellular phones, personal digital assistants, digital televisions, digital direct broadcast systems, digital recording devices, gaming consoles and the like. Operating on video data, however, may be very computationally intensive because of the large amounts of data that need to be constantly moved around. This normally requires systems with powerful processors, hardware accelerators, and/or substantial memory, particularly when video encoding is required. Such systems may typically use large amounts of power, which may make them less than suitable for certain applications, such as mobile applications.

Due to the ever growing demand for image and video capabilities, there is a need for power-efficient, high-performance multimedia processors that may be used in a wide range of applications, including mobile applications. Such multimedia processors may support multiple operations including audio processing, image sensor processing, video recording, media playback, graphics, three-dimensional (3D) gaming, and/or other similar operations.

Further limitations and disadvantages of conventional and traditional approaches will become apparent to one of skill in the art, through comparison of such systems with the present invention as set forth in the remainder of the present application with reference to the drawings.

### BRIEF SUMMARY OF THE INVENTION

A system and/or method for video processing utilizing a plurality of scalar cores and a single vector core, as set forth more completely in the claims.

Various advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A is a block diagram of an exemplary multimedia system that is operable to provide video processing utilizing a plurality of scalar cores and a single vector core in a multimedia processor, in accordance with an embodiment of the invention.

FIG. 1B is a block diagram of an exemplary multimedia processor that is operable to provide video processing utilizing a plurality of scalar cores and a single vector core, in accordance with an embodiment of the invention.

FIG. 2 is a block diagram of an exemplary video processing core architecture that is operable to provide video processing utilizing a plurality of scalar cores and a single vector core, in accordance with an embodiment of the invention.

FIG. 3A is a block diagram of an exemplary video processing unit that is operable to provide video processing utilizing two scalar cores and a single vector core, in accordance with an embodiment of the invention.

FIG. 3B is a block diagram that illustrates a more detailed information of the exemplary video processing unit of FIG. 3A, in accordance with an embodiment of the invention.

FIG. 4A is a flow chart that illustrates an exemplary video processing operation utilizing two scalar cores and a single vector core in a multimedia processor, in accordance with an embodiment of the invention.

FIG. 4B is a flow chart that illustrates an exemplary configuration of legacy code for use with two scalar cores and a single vector core in a multimedia processor, in accordance with an embodiment of the invention.

FIG. 5 is a flow chart that illustrates exemplary arbitration in the vector core, in accordance with an embodiment of the invention.

FIG. 6 is a block diagram of an exemplary video processing unit that is operable to provide video processing utilizing a plurality of scalar cores and a single vector core, in accordance with an embodiment of the invention.

### DETAILED DESCRIPTION OF THE INVENTION

Certain embodiments of the invention can be found in a method and system for video processing utilizing a plurality of scalar cores and a single vector core, in accordance with an embodiment of the invention. In accordance with various embodiments of the invention, a first scalar core in a multimedia processor may process data and/or instructions associated with a first image processing program. A second scalar core in the multimedia processor may process data and/or instructions associated with a second image processing program. A vector core in the multimedia processor may process one or both of data and/or instructions associated with the first image processing program and data and/or instructions associated with the second image processing program. The vector core may arbitrate the processing in the video core. The arbitration may be based on an alternating scheme, for example. The first image processing program may be independent from the second image processing program. The first scalar core, the second scalar core and the vector core are integrated on a single substrate of the multimedia processor.

In an embodiment of the invention, the first scalar core and the vector core may receive instructions associated with the first image processing program via a single instruction stream. The vector core may receive one or more of an operand, an index, and an address offset from a register file in the first scalar core. The vector core may communicate results generated by the vector core to a register file in the first scalar core. Similarly, the second scalar core and the vector core may receive instructions associated with the second image processing program via a single instruction stream. The vector core may receive one or more of an operand, an index, and an address offset from a register file in the second scalar core. The vector core may communicate results generated by the vector core to a register file in the second scalar core.

A first portion of a register file in the vector core may be accessed based on information received from the first scalar core. A second portion of the register file in the vector core, which is different from the first portion of the register file in the vector core, may be accessed based on information received from the second scalar core.

In some instances, by utilizing two scalar cores with a single vector core in a multimedia processor, system cost and/or hardware savings may be achieved when compared to systems having two scalar cores and two vector cores. A single vector core may be shared by two or more scalar cores because the workload distribution between them is typically such that the single vector core can accommodate the processing associated with the various scalar cores. When two or more scalar cores are utilized with a single vector core, however, existing or legacy code developed for systems with a single scalar core and a single vector core may not be applicable without possibly having to perform a significant amount of restructuring and/or rewriting. Instead, it is desirable that the multimedia processor be operable to take the existing programs and generate a set of programs that combine the vector operations and their associated scalar operations, along with a set of scalar-only programs, for example, to run in a system having multiple scalar cores and a single vector core. That is, each program running on such a multimedia processor may operate on the assumption of having access to the single vector core. In this manner, the use of a multimedia processor having multiple scalar cores that share a single vector core is transparent to the existing software. In other words, existing or legacy software may be ported to such a multimedia processor with little to no need for software restructuring and/or rewriting.

Accordingly, in accordance with various embodiments of the invention, a multimedia processor may receive data and instructions associated with image processing. In this regard, the image processing associated with the data and instructions received may be associated with an existing application, code, and/or software developed for a system comprising a single scalar core and a single vector core. The multimedia processor may configure the received data and instructions into data and instructions associated with a first image processing program and into data and instructions associated with a second image processing program independent of the first image processing program. The first image processing program may be configured to be handled by a first of two scalar cores and the vector core, while the data and instructions associated with the second image processing program may be configured to be handled by the other scalar core and the vector core.

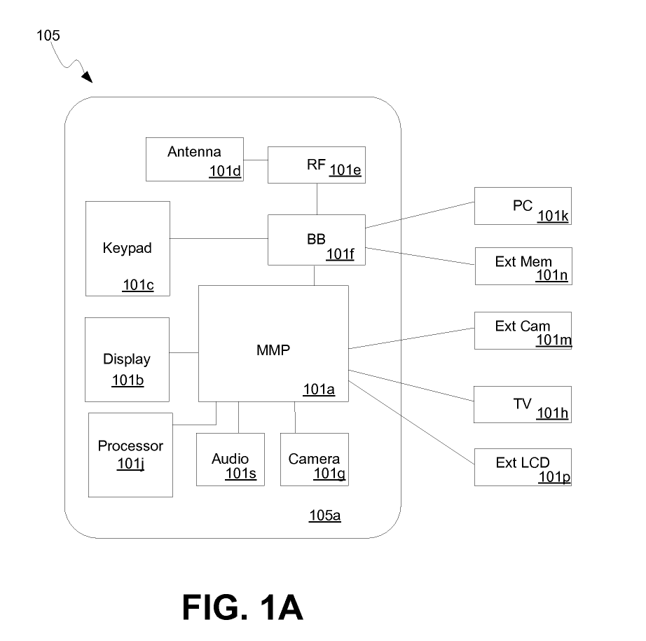

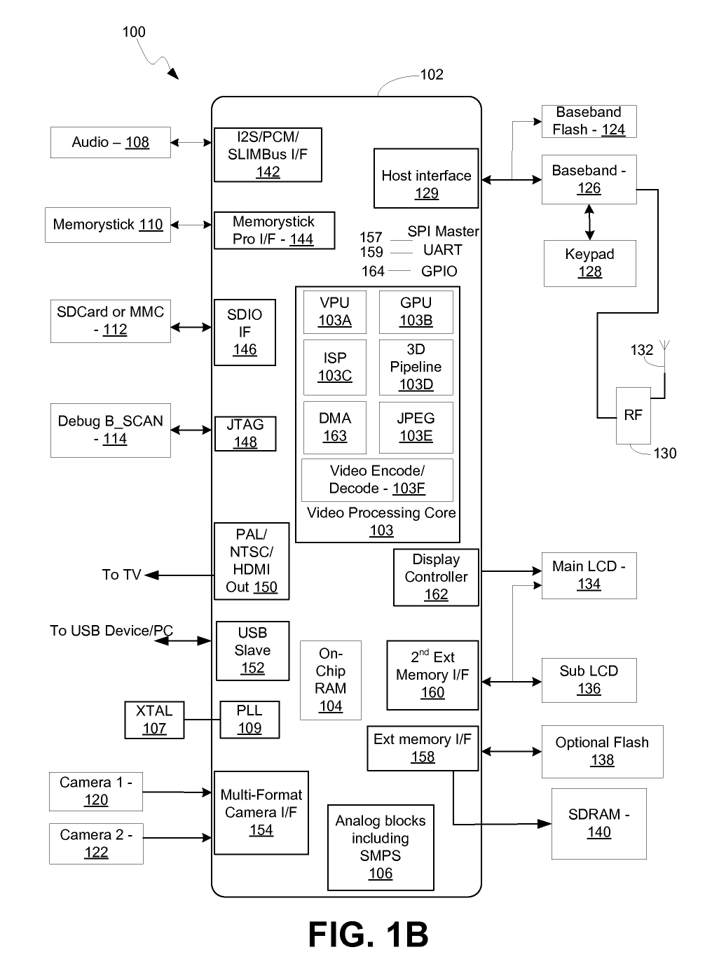

FIG. 1A is a block diagram of an exemplary multimedia system that is operable to provide video processing utilizing a plurality of scalar cores and a single vector core in a multimedia processor, in accordance with an embodiment of the invention. Referring to FIG. 1A, there is shown a mobile multimedia system 105 that comprises a mobile multimedia device 105a, a television (TV) 101h, a personal computer (PC) 101k, an external camera 101m, external memory 101n, and external liquid crystal display (LCD) 101p. The mobile multimedia device 105a may be a cellular telephone or other handheld communication device. The mobile multimedia device 105a may comprise a mobile multimedia processor (MMP) 101a, an antenna 101d, an audio block 101s, a radio frequency (RF) block 101e, a baseband processing block 101f, a display 101b, a keypad 101c, and a camera 101g. The display 101b may comprise an LCD and/or a light-emitting diode (LED).

The MMP 101a may comprise suitable circuitry, logic, interfaces, and/or code that may be operable to perform video and/or multimedia processing for the mobile multimedia device 105a. The MMP 101a may comprise, for example, a video processing unit (not shown) that may comprise a plurality of scalar cores and a single vector core for performing image processing operations. In one embodiment of the invention, the MMP 101a may comprise a first scalar core, a second scalar core, and a vector core. The first scalar core, the second scalar core, and the vector core may be integrated on a single substrate of the MMP 101a. The MMP 101a may also comprise integrated interfaces, which may be utilized to support one or more external devices coupled to the mobile multimedia device 105a. For example, the MMP 101a may support connections to a TV 101h, an external camera 101m, and an external LCD 101p.

The processor 101j may comprise suitable circuitry, logic, interfaces, and/or code that may be operable to control processes in the mobile multimedia system 105. Although not shown in FIG. 1A, the processor 101j may be coupled to a plurality of devices in and/or coupled to the mobile multimedia system 105.

In operation, the mobile multimedia device may receive signals via the antenna 101d. Received signals may be processed by the RF block 101e and the RF signals may be converted to baseband by the baseband processing block 101f. Baseband signals may then be processed by the MMP 101a. Audio and/or video data may be received from the external camera 101m, and image data may be received via the integrated camera 101g. During processing, the MMP 101a may utilize the external memory 101n for storing of processed data. Processed audio data may be communicated to the audio block 101s and processed video data may be communicated to the display 101b and/or the external LCD 101p, for example. The keypad 101c may be utilized for communicating processing commands and/or other data, which may be required for audio or video data processing by the MMP 101a.

In an embodiment of the invention, the MMP 101a may be operable to process video signals utilizing a plurality of scalar cores and a single vector core. More particularly, the MMP 101a may be operable to process data and/or instructions associated with a first image processing program and data and/or instructions associated with a second image processing program. In this regard, the MMP 101a may perform such processing utilizing, for example, a first scalar core, a second scalar core, and a single vector core. The first image processing program may be independent from the second image processing program. Independent image processing programs may also refer to threads, branches, and/or tasks of the same image processing program, for example.

FIG. 1B is a block diagram of an exemplary multimedia processor that is operable to provide video processing utilizing a plurality of scalar cores and a single vector core, in accordance with an embodiment of the invention. Referring to FIG. 1B, the mobile multimedia processor 102 may comprise suitable logic, circuitry, interfaces, and/or code that may be operable to perform video and/or multimedia processing for handheld multimedia products. For example, the mobile multimedia processor 102 may be designed and optimized for video record/playback, mobile TV and 3D mobile gaming, utilizing integrated peripherals and a video processing core. The mobile multimedia processor 102 may comprise a video processing core 103 that may comprise a vector processing unit (VPU) 103A, a graphic processing unit (GPU) 103B, an image sensor pipeline (ISP) 103C, a 3D pipeline 103D, a direct memory access (DMA) controller 163, a Joint Photographic Experts Group (JPEG) encoding/decoding module 103E, and a video encoding/decoding module 103F. The mobile multimedia processor 102 may also comprise on-chip RAM 104, an analog block 106, a phase-locked loop (PLL) 109, an audio interface (I/F) 142, a memory stick I/F 144, a Secure Digital input/output (SDIO) I/F 146, a Joint Test Action Group (JTAG) I/F 148, a TV output I/F 150, a Universal Serial Bus (USB) I/F 152, a camera I/F 154, and a host I/F 129. The mobile multimedia processor 102 may further comprise a serial peripheral interface (SPI) 157, a universal asynchronous receiver/transmitter (UART) I/F 159, a general purpose input/output (GPIO) pins 164, a display controller 162, an external memory I/F 158, and a second external memory I/F 160.

The video processing core 103 may comprise suitable logic, circuitry, interfaces, and/or code that may be operable to perform video processing of data. The on-chip Random Access Memory (RAM) 104 and the Synchronous Dynamic RAM (SDRAM) 140 comprise suitable logic, circuitry and/or code that may be adapted to store data such as image or video data.

The VPU 103A may comprise suitable logic, circuitry, code, and/or interfaces that may be operable to perform video processing of data. In one embodiment of the invention, the VPU 103A may comprise a plurality of scalar cores (not shown) and a single vector core (not shown) to perform image processing operations. For example, the VPU 103A may comprise a first scalar core, a second scalar core, and a single vector core. The first scalar core, the second scalar core, and the vector core may be integrated on a single substrate of the multimedia processor. Examples of implementations of vector processing units, such as the VPU 103A, for example, are described below.

In some instances, the video processing core 103 and/or the VPU 103A may be operable to combine the vector operations and their associated scalar operations, along with a set of scalar-only programs, for example, for existing or legacy programs, into a set of programs that may run in the VPU 103A architecture. In this regard, the video processing core 103 and/or the VPU 103A may configure data and instructions into data and instructions associated with a first image processing program to be handled by a first scalar core and a single vector core in the VPU 103A. The video processing core 103 and/or the VPU 103A may also configure the data and instructions and into data and instructions associated with a second image processing program independent of the first image processing program to be handled by a second scalar core and a single vector core in the VPU 103A. In this manner, the operation of existing or legacy software may remain largely, if not completely, independent and/or transparent to the number of scalar cores in the VPU 103A.

The above-described configuration may be performed by, for example, mapping, converting, and/or translating certain instructions, calls, functions, tasks, operations, and/or data to one or more instructions, calls, functions, tasks, operations, and/or data associated with the set of programs supported by the VPU 103A. The configuration may be performed in hardware, software, and/or a combination thereof in the video processing core 103 and/or the VPU 103A. In some instances, the software, code, and/or applications that operate in connection with the VPU 103A may have been developed for a system having two scalar cores and a single vector core. In such instances, the configuration described above may not be necessary and hardware and/or software associated with configuration operations may be disabled.

The image sensor pipeline (ISP) 103C may comprise suitable circuitry, logic and/or code that may be operable to process image data. The ISP 103C may perform a plurality of processing techniques comprising filtering, demosaic, lens shading correction, defective pixel correction, white balance, image compensation, Bayer interpolation, color transformation, and post filtering, for example. The processing of image data may be performed on variable sized tiles, reducing the memory requirements of the ISP 103C processes.

The GPU 103B may comprise suitable logic, circuitry, interfaces, and/or code that may be operable to offload graphics rendering from a general processor, such as the processor 101j, described with respect to FIG. 1A. The GPU 103B may be operable to perform mathematical operations specific to graphics processing, such as texture mapping and rendering polygons, for example.

The 3D pipeline 103D may comprise suitable circuitry, logic and/or code that may enable the rendering of 2D and 3D graphics. The 3D pipeline 103D may perform a plurality of processing techniques comprising vertex processing, rasterizing, early-Z culling, interpolation, texture lookups, pixel shading, depth test, stencil operations and color blend, for example. The 3D pipeline 103D may be operable to perform tile mode rendering in two separate phases, a first phase comprising a binning process or operation, and a second phase comprising a rendering process or operation

The JPEG module 103E may comprise suitable logic, circuitry, interfaces, and/or code that may be operable to encode and/or decode JPEG images. JPEG processing may enable compressed storage of images without significant reduction in quality.

The video encoding/decoding module 103F may comprise suitable logic, circuitry, interfaces, and/or code that may be operable to encode and/or decode images, such as generating full 1080p HD video from H.264 compressed data, for example. In addition, the video encoding/decoding module 103F may be operable to generate standard definition (SD) output signals, such as phase alternating line (PAL) and/or national television system committee (NTSC) formats.

Also shown in FIG. 1B are an audio block 108 that may be coupled to the audio interface I/F 142, a memory stick 110 that may be coupled to the memory stick I/F 144, an SD card block 112 that may be coupled to the SDIO IF 146, and a debug block 114 that may be coupled to the JTAG I/F 148. The PAL/NTSC/high definition multimedia interface (HDMI) TV output I/F 150 may be utilized for communication with a TV, and the USB 1.1, or other variant thereof, slave port I/F 152 may be utilized for communications with a PC, for example. A crystal oscillator (XTAL) 107 may be coupled to the PLL 109. Moreover, cameras 120 and/or 122 may be coupled to the camera I/F 154.

Moreover, FIG. 1B shows a baseband processing block 126 that may be coupled to the host interface 129, a radio frequency (RF) processing block 130 coupled to the baseband processing block 126 and an antenna 132, a basedband flash 124 that may be coupled to the host interface 129, and a keypad 128 coupled to the baseband processing block 126. A main LCD 134 may be coupled to the mobile multimedia processor 102 via the display controller 162 and/or via the second external memory interface 160, for example, and a subsidiary LCD 136 may also be coupled to the mobile multimedia processor 102 via the second external memory interface 160, for example. Moreover, an optional flash memory 138 and/or an SDRAM 140 may be coupled to the external memory I/F 158.

In operation, the mobile multimedia processor 102 may perform multimedia processing operations. More particularly, the VPU 103A in the mobile multimedia processor 102 may perform image processing operations. In this regard, when the VPU 103A comprises a first scalar core, a second scalar core, and a single vector core, for example, the first scalar core may process data and/or instructions associated with the first image processing program, the second scalar core may process data and/or instructions associated with a second image processing program, and the vector core may process data and/or instructions associated with either or both of the first and second image processing programs. The first scalar core, the second scalar core, and the vector core may be integrated on a single substrate of the mobile multimedia processor 102. The first image processing program and the second image processing program may be independent from each other. Moreover, independent image processing programs may also refer to threads, branches, and/or tasks of the same image processing program, for example.

The first scalar core and the vector core in the VPU 103A may each receive instructions associated with the first image processing program via an instruction stream common to both the first scalar core and the vector core. Similarly, the second scalar core and the vector core in the VPU 103A may each receive instructions associated with the second image processing program via an instruction stream common to both the second scalar core and the vector core.

The vector core in the VPU 103A may receive information from a register file in the first scalar core and/or from a register file in the second scalar core. A first portion of a register file in the vector core may be accessed based on information received from the first scalar core, while a second portion of the register file in the vector core, which may be different from the first portion of the register file in the vector core, may be accessed based on information received from the second scalar core. The vector core in the VPU 103A may communicate results generated by the vector core to a register file in the first scalar core and/or to a register file in the second scalar core.

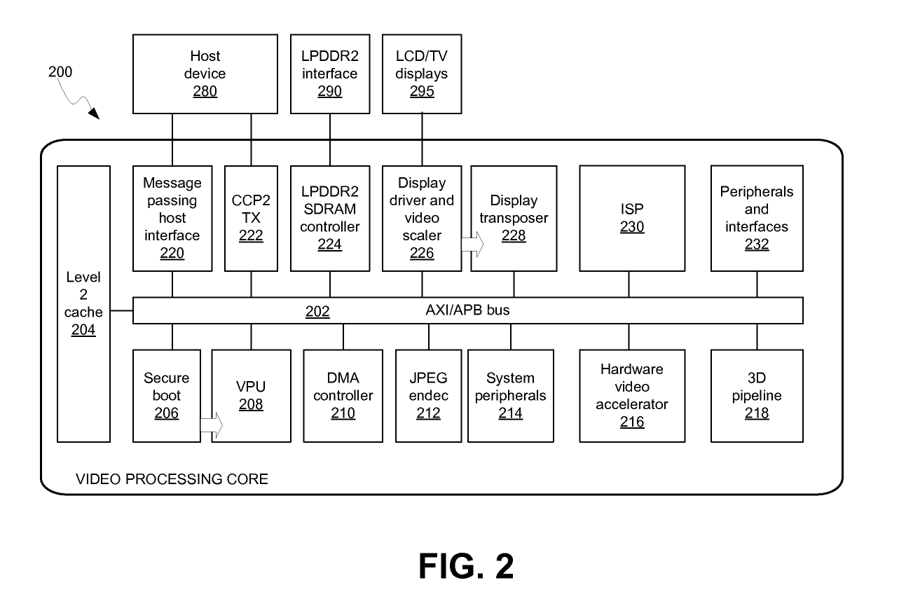

FIG. 2 is a block diagram of an exemplary video processing core architecture that is operable to provide video processing utilizing a plurality of scalar cores and a single vector core, in accordance with an embodiment of the invention. Referring to FIG. 2, there is shown a video processing core 200 comprising suitable logic, circuitry, interfaces and/or code that may be operable for high performance video and multimedia processing. The architecture of the video processing core 200 may provide a flexible, low power, and high performance multimedia solution for a wide range of applications, including mobile applications, for example. By using dedicated hardware pipelines in the architecture of the video processing core 200, such low power consumption and high performance goals may be achieved. The video processing core 200 may correspond to, for example, the video processing core 103 described above with respect to FIG. 1B.

The video processing core 200 may support multiple capabilities, including image sensor processing, high rate (e.g., 30 frames-per-second) high definition (e.g., 1080p) video encoding and decoding, 3D graphics, high speed JPEG encode and decode, audio codecs, image scaling, and/or LCD and TV outputs, for example.

In one embodiment, the video processing core 200 may comprise an Advanced eXtensible Interface/Advanced Peripheral (AXI/APB) bus 202, a level 2 cache 204, a secure boot 206, a Vector Processing Unit (VPU) 208, a DMA controller 210, a JPEG encoder/decoder (endec) 212, a systems peripherals 214, a message passing host interface 220, a Compact Camera Port 2 (CCP2) transmitter (TX) 222, a Low-Power Double-Data-Rate 2 SDRAM (LPDDR2 SDRAM) controller 224, a display driver and video scaler 226, and a display transposer 228. The video processing core 200 may also comprise an ISP 230, a hardware video accelerator 216, a 3D pipeline 218, and peripherals and interfaces 232. In other embodiments of the video processing core 200, however, fewer or more components than those described above may be included.

In one embodiment, the VPU 208, the ISP 230, the 3D pipeline 218, the JPEG endec 212, the DMA controller 210, and/or the hardware video accelerator 216, may correspond to the VPU 103A, the ISP 103C, the 3D pipeline 103D, the JPEG 103E, the DMA 163, and/or the video encode/decode 103F, respectively, described above with respect to FIG. 1B.

Operably coupled to the video processing core 200 may be a host device 280, an LPDDR2 interface 290, and/or LCD/TV displays 295. The host device 280 may comprise a processor, such as a microprocessor or Central Processing Unit (CPU), microcontroller, Digital Signal Processor (DSP), or other like processor, for example. In some embodiments, the host device 280 may correspond to the processor 101j described above with respect to FIG. 1A. The LPDDR2 interface 290 may comprise suitable logic, circuitry, and/or code that may be operable to allow communication between the LPDDR2 SDRAM controller 224 and memory. The LCD/TV displays 295 may comprise one or more displays (e.g., panels, monitors, screens, cathode-ray tubes (CRTs)) for displaying image and/or video information. In some embodiments, the LCD/TV displays 295 may correspond to one or more of the TV 101h and the external LCD 101p described above with respect to FIG. 1A, and the main LCD 134 and the sub LCD 136 described above with respect to FIG. 1B.

The message passing host interface 220 and the CCP2 TX 222 may comprise suitable logic, circuitry, and/or code that may be operable to allow data and/or instructions to be communicated between the host device 280 and one or more components in the video processing core 200. The data communicated may include image and/or video data, for example.

The LPDDR2 SDRAM controller 224 and the DMA controller 210 may comprise suitable logic, circuitry, and/or code that may be operable to control the access of memory by one or more components and/or processing blocks in the video processing core 200.

The VPU 208 may comprise suitable logic, circuitry, and/or code that may be operable for data processing while maintaining high throughput and low power consumption. The VPU 208 may allow flexibility in the video processing core 200 such that software routines, for example, may be inserted into the processing pipeline. The VPU 208 may comprise a plurality of scalar cores and a vector core, for example. Each of the scalar cores may use a Reduced Instruction Set Computer (RISC)-style scalar instruction set and the vector core may use a vector instruction set, for example. Scalar and vector instructions may be executed in parallel. In one embodiment of the invention, the VPU 208 may comprise a first scalar core, a second scalar core, and a single vector core. The scalar cores and the vector core may be integrated on a single substrate of the video processing core 200.

The video processing core 200 and/or the VPU 208 may be operable to combine the vector operations and their associated scalar operations, along with a set of scalar-only programs, for example, for existing or legacy programs, into a set of programs that may run in the VPU 208 architecture. In this regard, the video processing core 200 and/or the VPU 208 may configure data and instructions into data and instructions associated with a first image processing program to be handled by a first scalar core and a single vector core in the VPU 208. The video processing core 200 and/or the VPU 208 may also configure the data and instructions and into data and instructions associated with a second image processing program independent of the first image processing program to be handled by a second scalar core and a single vector core in the VPU 208. In this manner, the operation of existing or legacy software may remain largely, if not completely, independent and/or transparent to the number of scalar cores in the VPU 208.

The above-described configuration may be performed by, for example, mapping, converting, and/or translating certain instructions, calls, functions, tasks, operations, and/or data to one or more instructions, calls, functions, tasks, operations, and/or data associated with the set of programs supported by the VPU 208. The configuration may be performed in hardware, software, and/or a combination thereof in the video processing core 200 and/or the VPU 208. In some instances, the software, code, and/or applications that operate in connection with the VPU 208, rather than being existing or legacy software, code, and/or applications, may have been developed specifically for the architecture of the VPU 208. In such instances, the configuration described above may not be necessary and hardware and/or software associated with configuration operations may be disabled.

In another embodiment of the invention, the VPU 208 may comprise more than two (2) scalar cores and a single vector core. The scalar cores and the vector core may be integrated on a single substrate of the video processing core 200. In such embodiments of the invention, the video processing core 200 and/or the VPU 208 may enable the use of existing or legacy software, code, and/or applications, as well as software, code, and/or applications specifically developed for the architecture of the VPU 208.

Although not shown in FIG. 2, the VPU 208 may comprise one or more Arithmetic Logic Units (ALUs), a scalar data bus, a scalar register file, one or more Pixel-Processing Units (PPUs) for vector operations, a vector data bus, a vector register file, a Scalar Result Unit (SRU) that may operate on one or more PPU outputs to generate a value that may be provided to a scalar core. Moreover, the VPU 208 may comprise its own independent level 1 instruction and data cache.

The ISP 230 may comprise suitable logic, circuitry, and/or code that may be operable to provide hardware accelerated processing of data received from an image sensor (e.g., charge-coupled device (CCD) sensor, complimentary metal-oxide semiconductor (CMOS) sensor). The ISP 230 may comprise multiple sensor processing stages in hardware, including demosaicing, geometric distortion correction, color conversion, denoising, and/or sharpening, for example. The ISP 230 may comprise a programmable pipeline structure. Because of the close operation that may occur between the VPU 208 and the ISP 230, software algorithms may be inserted into the pipeline.

The hardware video accelerator 216 may comprise suitable logic, circuitry, and/or code that may be operable for hardware accelerated processing of video data in any one of multiple video formats such as H.264, Windows Media 8/9/10 (VC-1), MPEG-1, MPEG-2, and MPEG-4, for example. For H.264, for example, the hardware video accelerator 216 may encode at full HD 1080p at 30 frames-per-second (fps). For MPEG-4, for example, the hardware video acceleration 216 may encode a HD 720p at 30 fps. For H.264, VC-1, MPEG-1, MPEG-2, and MPEG-4, for example, the hardware video accelerator 216 may decode at full HD 1080p at 30 fps or better. The hardware video accelerator 216 may be operable to provide concurrent encoding and decoding for video conferencing and/or to provide concurrent decoding of two video streams for picture-in-picture applications, for example.

The 3D pipeline 218 may comprise suitable logic, circuitry, and/or code that may be operable to provide 3D rendering operations for use in, for example, graphics applications. The 3D pipeline 218 may support OpenGL-ES 2.0, OpenGL-ES 1.1, and OpenVG 1.1, for example. The 3D pipeline 218 may comprise a multi-core programmable pixel shader, for example. The 3D pipeline 218 may be operable to handle 32M triangles-per-second (16M rendered triangles-per-second), for example. The 3D pipeline 218 may be operable to handle 1G rendered pixels-per-second with Gouraud shading and one bi-linear filtered texture, for example. The 3D pipeline 218 may support four times (4×) full-screen anti-aliasing at full pixel rate, for example.

The 3D pipeline 218 may comprise a tile mode architecture in which a rendering operation may be separated into a first phase and a second phase. During the first phase, the 3D pipeline 218 may utilize a coordinate shader to perform a binning operation. During the second phase, the 3D pipeline 218 may utilize a vertex shader to render images such as those in frames in a video sequence, for example.

The JPEG endec 212 may comprise suitable logic, circuitry, and/or code that may be operable to provide processing (e.g., encoding, decoding) of images. The encoding and decoding operations need not operate at the same rate. For example, the encoding may operate at 120M pixels-per-second and the decoding may operate at 50M pixels-per-second depending on the image compression.

The display driver and video scaler 226 may comprise suitable logic, circuitry, and/or code that may be operable to drive the TV and/or LCD displays in the TV/LCD displays 295. In this regard, the display driver and video scaler 226 may output to the TV and LCD displays concurrently and in real time, for example. Moreover, the display driver and video scaler 226 may comprise suitable logic, circuitry, and/or code that may be operable to scale, transform, and/or compose multiple images. The display driver and video scaler 226 may support displays of up to full HD 1080p at 60 fps.

The display transposer 228 may comprise suitable logic, circuitry, and/or code that may be operable for transposing output frames from the display driver and video scaler 226. The display transposer 228 may be operable to convert video to 3D texture format and/or to write back to memory to allow processed images to be stored and saved.

The secure boot 206 may comprise suitable logic, circuitry, and/or code that may be operable to provide security and Digital Rights Management (DRM) support. The secure boot 206 may comprise a boot Read Only Memory (ROM) that may be used to provide secure root of trust. The secure boot 206 may comprise a secure random or pseudo-random number generator and/or secure (One-Time Password) OTP key or other secure key storage.

The AXI/APB bus 202 may comprise suitable logic, circuitry, and/or interface that may be operable to provide data and/or signal transfer between various components of the video processing core 200. In the example shown in FIG. 2, the AXI/APB bus 202 may be operable to provide communication between two or more of the components the video processing core 200.

The AXI/APB bus 202 may comprise one or more buses. For example, the AXI/APB bus 202 may comprise one or more AXI-based buses and/or one or more APB-based buses. The AXI-based buses may be operable for cached and/or uncached transfer, and/or for fast peripheral transfer. The APB-based buses may be operable for slow peripheral transfer, for example. The transfer associated with the AXI/APB bus 202 may be of data and/or instructions, for example.

The AXI/APB bus 202 may provide a high performance system interconnection that allows the VPU 208 and other components of the video processing core 200 to communicate efficiently with each other and with external memory.

The level 2 cache 204 may comprise suitable logic, circuitry, and/or code that may be operable to provide caching operations in the video processing core 200. The level 2 cache 204 may be operable to support caching operations for one or more of the components of the video processing core 200. The level 2 cache 204 may complement level 1 cache and/or local memories in any one of the components of the video processing core 200. For example, when the VPU 208 comprises its own level 1 cache, the level 2 cache 204 may be used as complement. The level 2 cache 204 may comprise one or more blocks of memory. In one embodiment, the level 2 cache 204 may be a 128 kilobyte four-way set associative cache comprising four blocks of memory (e.g., Static RAM (SRAM)) of 32 kilobytes each.

The system peripherals 214 may comprise suitable logic, circuitry, and/or code that may be operable to support applications such as, for example, audio, image, and/or video applications. In one embodiment, the system peripherals 214 may be operable to generate a random or pseudo-random number, for example. The capabilities and/or operations provided by the peripherals and interfaces 232 may be device or application specific.

In operation, the video processing core 200 may perform multiple multimedia tasks simultaneously without degrading individual function performance. In an exemplary embodiment of the invention, the VPU 208 of the video processing core 200 may be utilized to perform image processing operations in connection with various usage cases or scenarios. In one such case or scenario, the video processing core 200 may be utilized for movie playback applications in which the VPU 208 may perform discrete cosine transform (DCT) operations for MPEG-4 and/or 3D effects, for example. In another scenario, the video processing core 200 may be utilized for video capture and encoding applications in which the VPU 208 may perform DCT operations for MPEG-4 and/or additional software functions in the ISP 230 pipeline, for example. In another scenario, the video processing core 200 may be utilized for video game applications in which the VPU 208 may execute the gaming engine and/or may supply primitives to the 3D pipeline, for example. In another scenario, the video processing core 200 may be utilized for still image capture in which the VPU 208 may perform additional software functions in the ISP 230 pipeline, for example.

In each of the various usage cases or scenarios described above, the image processing operations performed by the VPU 208 may be implemented utilizing parallel programs that are executed independent from each other. In such instances, a first scalar core in the VPU 208 may process data and/or instructions associated with a first image processing program, a second scalar core in the VPU 208 may process data and/or instructions associated with a second image processing program, and a vector core in the VPU 208 may process data and/or instructions associated with either or both of the first image processing program and the second image processing program. The first image processing program and the second image processing program may be independent from each other. Moreover, independent image processing programs may also refer to threads, branches, and/or tasks of the same image processing program, for example.

The first scalar core and the vector core in the VPU 208 may each receive instructions associated with the first image processing program via an instruction stream common to both the first scalar core and the vector core. Similarly, the second scalar core and the vector core in the VPU 208 may each receive instructions associated with the second image processing program via an instruction stream common to both the second scalar core and the vector core.

The vector core in the VPU 208 may receive information from a register file in the first scalar core and/or from a register file in the second scalar core. A first portion of a register file in the vector core may be accessed based on information received from the first scalar core, while a second portion of the register file in the vector core, which may be different from the first portion of the register file in the vector core, may be accessed based on information received from the second scalar core. The vector core in the VPU 208 may communicate results generated by the vector core to a register file in the first scalar core and/or to a register file in the second scalar core.

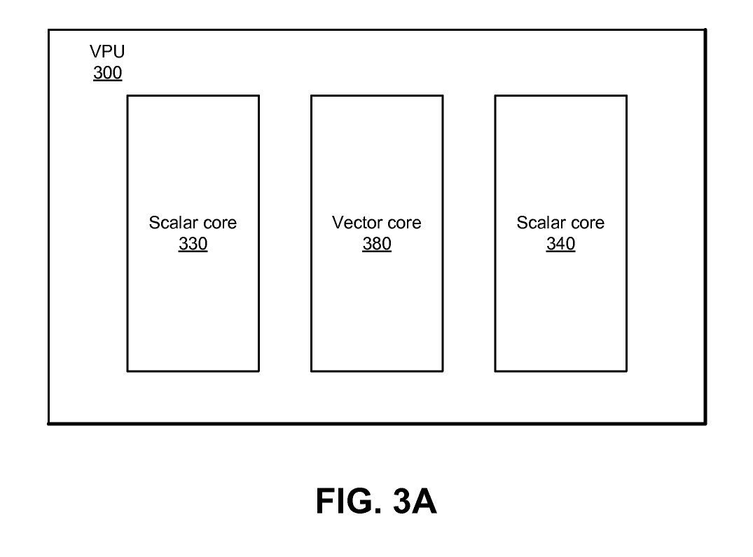

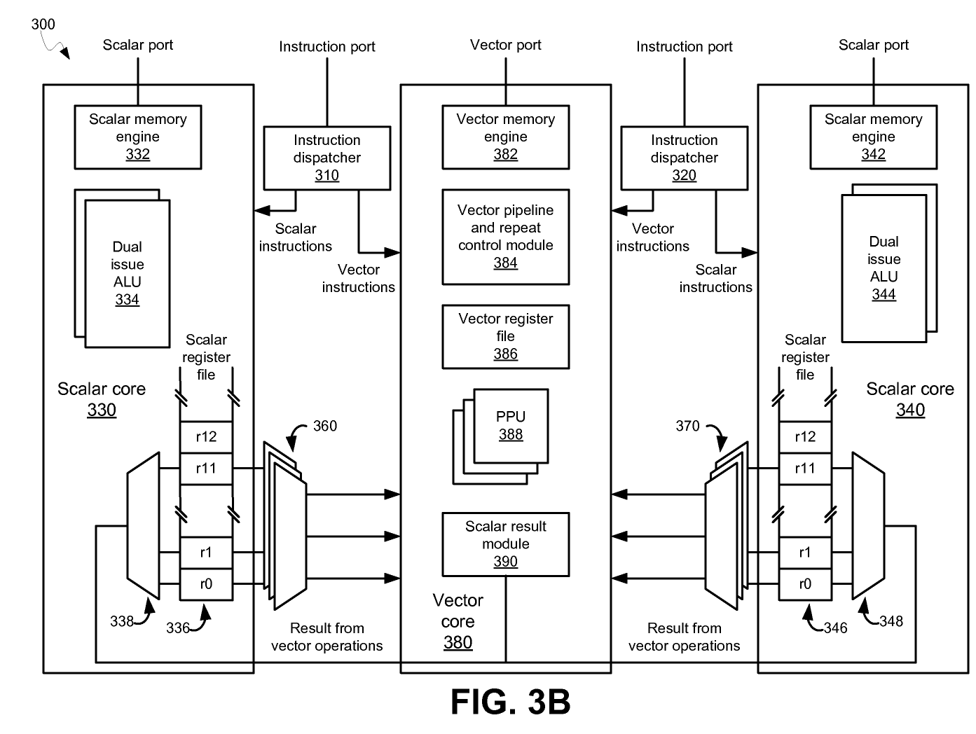

FIG. 3A is a block diagram of an exemplary video processing unit that is operable to provide video processing utilizing two scalar cores and a single vector core, in accordance with an embodiment of the invention. Referring to FIG. 3A, there is shown a VPU 300 that may comprise a first scalar core or scalar core 330, a second scalar core or scalar core 340, and a single vector core 380. The scalar cores 330 and 340 may be communicatively coupled to the vector core 380. The VPU 300 may correspond to, for example, the VPU 103A or the VPU 208 described above.

Each of the scalar cores 330 and 340 may comprise suitable logic, circuitry, code, and/or interfaces that may operate on a single data item with an instruction. Each of the scalar cores 330 and 340 may utilize a RISC-style scalar instruction set, for example. The vector core 380 may comprise suitable logic, circuitry, code, and/or interfaces that may operate on multiple data items with a single instruction, where the multiple data items may be organized as a one-dimensional array of data typically referred to as a vector, for example. The instructions associated with the scalar cores 330 and 340, and with the vector core 380 may be executed in parallel.

In one embodiment of the invention, the scalar cores 330 and 340, and the vector core 380 may be integrated on a substrate of a single integrated circuit (IC) or chip comprising the VPU 300. In this regard, the VPU 300 may itself be integrated with other components and/or modules into a single IC or chip comprising a video processing core such as the video processing core 103 and the video processing core 200 described above. Moreover, the video processing core comprising the VPU 300 may be integrated with other components and/or modules into a single IC or chip comprising a mobile multimedia processor such as the MMP 101a and the mobile multimedia processor 102.

In operation, the scalar core 330 may process data and/or instructions associated with a first image processing program. The scalar core 340 may process data and/or instructions associated with a second image processing program. The vector core 380 may process data and/or instructions associated with either or both of the first image processing program and the second image processing program.

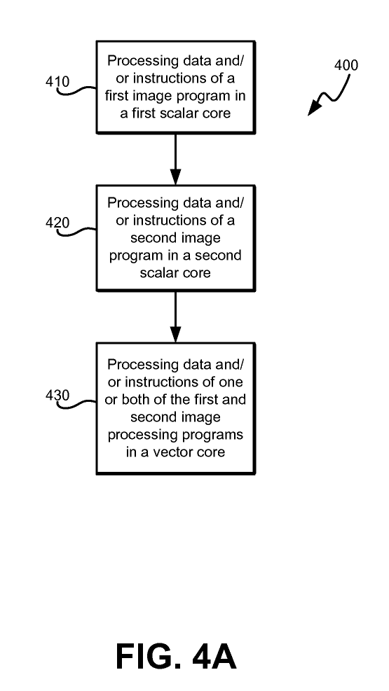

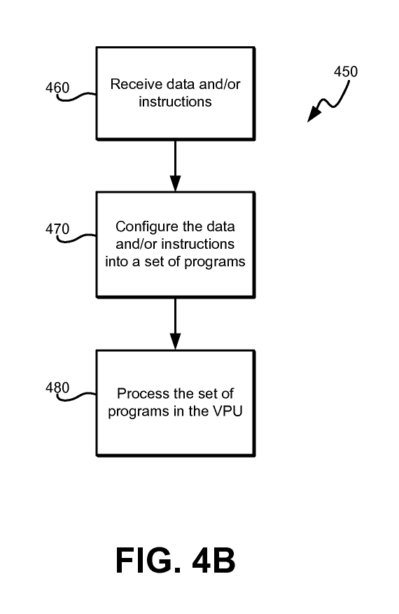

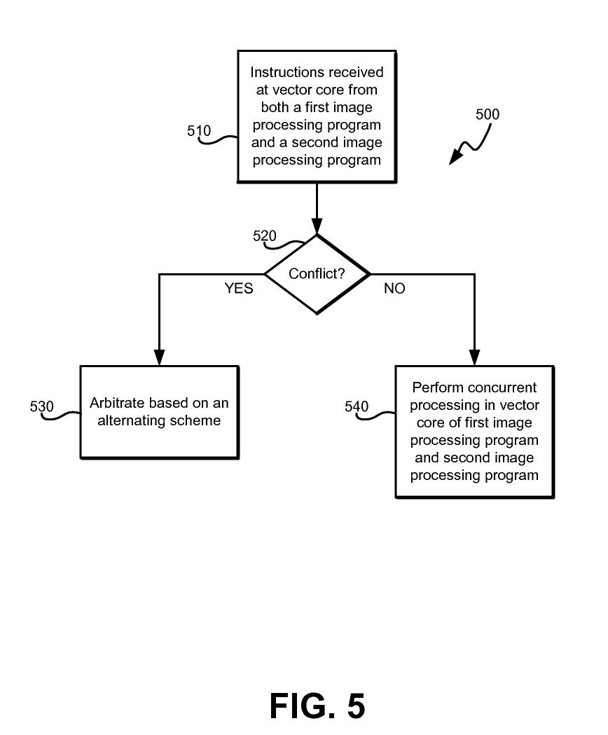

FIG. 3B is a block diagram that illustrates a more detailed information of the exemplary video processing unit of FIG. 3A, in accordance with an embodiment of the invention. Referring to FIG. 3B, there is shown the VPU 300 that may comprise the scalar core 330, the scalar core 340, and the vector core 380 shown above in FIG. 3A. Examples of the operation of the VPU 300 are provided below with respect to FIGS. 4 and 5.

The scalar core 330 may comprise a scalar memory engine 332, a dual issue ALU 334, a scalar register file 336, and a multiplexer 338. The scalar core 340 may comprise a scalar memory engine 342, a dual issue ALU 344, a scalar register file 346, and a multiplexer 348. The vector core 380 may comprise a vector memory engine 382, a vector pipeline and repeat control module 384, a vector register file 386, a plurality of PPUs 388, and a scalar result module 390. Each of the scalar cores 330 and 340 may be a 32-bit scalar processor, for example. The vector core 380 may be operable to perform a plurality of image processing operations or tasks and/or 3D graphics calculations, for example. Also shown in FIG. 3B are an instruction dispatcher 310, an instruction dispatcher 320, multiplexers 360, and multiplexers 370.

The instruction dispatcher 310 may comprise suitable logic, circuitry, code, and/or interfaces that may be operable to fetch, decode, sequence, and/or dispatch scalar instructions to the scalar core 330 and vector instructions to the vector core 380. The instruction dispatcher 310 may comprise a single port to memory to be utilized for code fetches and/or to implement branch prediction to, for example, maintain the flow of instructions to the execution pipelines. In this regard, the instruction dispatcher 310 may enable a single instruction stream to be utilized for the scalar core 330 and the vector core 380. The instructions associated with the single instruction stream to the instruction dispatcher 310 may correspond to a first image processing program.

The instruction dispatcher 320 may comprise suitable logic, circuitry, code, and/or interfaces that may be operable to fetch, decode, sequence, and/or dispatch scalar instructions to the scalar core 340 and vector instructions to the vector core 380. The instruction dispatcher 320 may comprise a single port to memory to be utilized for code fetches and/or to implement branch prediction to, for example, maintain the flow of instructions to the execution pipelines. In this regard, the instruction dispatcher 320 may enable a single instruction stream to be utilized for the scalar core 340 and the vector core 380. The instructions associated with the single instruction stream to the instruction dispatcher 320 may correspond to a second image processing program, which may be independent from the first image processing program corresponding to the single instruction stream to the instruction dispatcher 310.

The scalar register files 336 and 346 may each comprise suitable logic, circuitry, code, and/or interfaces that may be operable to store values. In one embodiment of the invention, the scalar register files 336 and 346 may each comprise thirty-two (32) 32-bit registers. The bottom sixteen (16) registers, r0-r15, for example, may be the main working registers of the scalar core, with a portion of those registers also being accessible by the vector core 380. For example, a value stored in one of the main working registers can be used by the vector core 380 as an operand for a vector operation, an index into the vector register file 386, and/or an address for vector memory accesses. In this regard, values from the scalar register file 336 in the scalar core 330 may be accessed by the vector core 380 via the multiplexers 360 and values from the scalar register file 346 in the scalar core 340 may be accessed by the vector core 380 via the multiplexers 370.

Moreover, a portion of the main working registers in the scalar register files 336 and 346 may be utilized to receive results of operations performed by the vector core 380. In this regard, results from the vector core 380 may be communicated to the scalar register file 336 in the scalar core 330 via the multiplexer 338 and results from the vector core 380 may be communicated to the scalar register file 346 in the scalar core 340 via the multiplexer 348. Some of the registers in the scalar register files 336 and 346 may also be utilized for dedicated functions within the VPU 300, such as a program counter, a status register, a task pointer, a supervisor stack pointer, a user stack pointer, a link register, a secure kernel stack pointer, and/or a global pointer, for example.

Each of the dual issue ALU 334 and 344 may comprise suitable logic, circuitry, code, and/or interfaces that may be operable to perform superscalar execution, to issue two integer operations, and to issue an integer operation and a floating-point operation concurrently. Integer operations may be able to execute in a single cycle and a forwarding path may be provided such that the result can be used by the following instruction without incurring any stalls. Complex integer operations may be pipelined over two cycles, for example. In such instances, a single pipeline stall may be inserted if the following instruction references the result. Floating-point operations may be able to execute over three clock cycles, for example. These operations may be pipelined such that a floating-point operation may be issued at each clock cycle. However, a pipeline stall may be inserted if either of the two following instructions references the result.

Each of the scalar memory engines 332 and 342 may comprise suitable logic, circuitry, code, and/or interfaces that may be operable to perform data communication with memory. The scalar memory engines 332 and 342 may be operable to alleviate memory access latency, once the required address information has been calculated, by posting scalar memory accesses in a queue outside the pipeline to allow subsequent instructions to continue without having to wait for the memory operation to complete. The scalar cores may mark those registers for which there are outstanding load operations and may stall any instructions that reference such registers before the memory system has returned the required data. A read may be outstanding when it has been issued by the scalar core and the data has not been returned. A write may be outstanding when it has been issued by the scalar core and the write response has not been received.

The vector register file 386 may comprise suitable logic, circuitry, code, and/or interfaces that may comprise pixel values associated with one or more portions of an image. In one embodiment of the invention, the vector register file 386 may comprise sixty-four (64) rows of 64 8-bit pixel values. Groups of sixteen (16) contiguous pixels may be written or read at once, the first of each such group of pixels being identified by its natural (x,y) coordinates. The 16 pixels in any one of such groups may be horizontally contiguous or vertically contiguous.

The PPUs 388 may comprise suitable logic, circuitry, code, and/or interfaces that may be operable to provide parallel processing of a plurality of values. In one embodiment of the invention, when the vector core 380 may comprise 16 32-bit PPUs 388 that may operate in parallel on two sets of 16 values. These sets of values may be read from the vector register file 386 where groups of pixels may be addressed directly using two-dimensional coordinates and to which results may be returned. The PPUs 388 may support a wide range of arithmetic and logical operations, both saturating and non-saturating, including a plurality of instructions particular to image processing operations. Moreover, the PPUs 338 may support both integer and floating-point arithmetic. Although not shown, each PPU 338 may comprise a 32-bit ALU and an accumulator, which can be incremented using the result of the ALU operation and then returned.

The vector memory engine 382 may comprise suitable logic, circuitry, code, and/or interfaces that may be operable to allow memory operations to be posted and executed in parallel with subsequent vector data processing instructions. The vector memory engine 382 may be operable to hide address latency in memory accesses by processing vector load and/or storing accesses independently from the main vector pipeline. The vector memory engine 382 may then process blocks of data in parallel with storing the previous block and/or loading the next. The vector pipeline may be stalled when subsequent instructions attempt to read or write a location in the vector register file 386 for which there is a load or store operation outstanding.

The scalar result module 390 may comprise suitable logic, circuitry, code, and/or interfaces that may operate on at least a portion of the PPUs 388 and may be operable to provide results back to the scalar register file 336 in the scalar core 330 and/or to the scalar register file 346 in the scalar core 340. The scalar result module 390 may perform various operations such as a sum of valid results, for example. The scalar result module 390 may also perform indexing of a maximum value, for example.

The vector pipeline and repeat control module 384 may comprise suitable logic, circuitry, code, and/or interfaces that may be operable to allow vector instructions that have been fetched and decoded to be executed independently from that of the corresponding scalar core instruction allowing subsequent scalar instructions to execute in parallel with the vector operations. The vector pipeline and repeat control module 384 may be operable to implement repeat operations. Such repeat capabilities, in addition to enabling a set of incrementing address modes, enables the vector core 380 to utilize a single instruction to process an entire block of data.

FIG. 4A is a flow chart that illustrates an exemplary video processing operation utilizing two scalar cores and a single vector core in a multimedia processor, in accordance with an embodiment of the invention. Referring to FIG. 4A, there is shown a flow chart 400 that describes exemplary operation of the VPU 300 described above. In step 410, the scalar core 330 may process data and/or instructions associated with a first image processing program, for example. The scalar core 330 may receive data via the scalar memory engine 332 and scalar instructions via the instruction dispatcher 310. The instruction dispatcher 310 may fetch, decode, and/or sequence the scalar instructions before dispatching the scalar instructions to the scalar core 330. The dual issue ALU 334 in the scalar core 330 may process data in accordance with the scalar instructions received.

In step 420, the scalar core 340 may process data and/or instructions associated with a second image processing program, for example. The second image processing program may be independent from the first image processing program in step 410. The scalar core 340 may receive data via the scalar memory engine 342 and scalar instructions via the instruction dispatcher 320. The instruction dispatcher 320 may fetch, decode, and/or sequence the scalar instructions before dispatching the scalar instructions to the scalar core 340. The dual issue ALU 344 in the scalar core 340 may process data in accordance with the scalar instructions received.

In step 430, the vector core 380 may process data and/or instructions associated with one or both of the first image processing program and the second image processing program. The vector core 380 may receive data such as pixel values, for example, via the vector memory engine 382 and vector instructions via the instruction dispatchers 310 and 320. In this regard, vector instructions associated with the first image processing program may be received via the instruction dispatcher 310 and vector instructions associated with the second image processing program may be received via the instruction dispatcher 320. The instruction dispatchers 310 and 320 may each fetch, decode, and/or sequence the vector instructions. Pixel values received by the vector core 380 for processing may be stored in the vector register file 386. The PPUs 388 may process the pixel values in accordance with the vector instructions received.

The processing of data and/or instructions in the vector core 380 may comprise accessing of operands, indices, and/or addresses from the scalar register file 336 in the scalar core 330 and/or from the scalar register file 346 in the scalar core 340. Moreover, processing of data and/or instructions in the vector core 380 may comprise communicating results from the scalar result module 390 to the scalar register file 336 in the scalar core 330 and/or to the scalar register file 346 in the scalar core 340.

The above description of the VPU 300 and its operation are provided by way of example and not of limitation. Equivalent implementations and/or operations may be substituted without departing from the scope of the present invention.

FIG. 4B is a flow chart that illustrates an exemplary configuration of legacy code for use with two scalar cores and a single vector core in a multimedia processor, in accordance with an embodiment of the invention. Referring to FIG. 4B, there is shown a flow chart 450 associated with processing of existing or legacy software, code, and/or applications for use with the VPU 300 described above. At step 460, a video processing core in a multimedia processor, wherein such video processing core may comprise the VPU 300, may be operable to process data and/or instructions associated with an image processing operation. Examples of such video processing core may include the video processing core 103 in FIG. 1B and the video processing core 200 in FIG. 2. The organization and/or the type of instructions and/or of data associated with the image processing operation may be based on existing or legacy software, code, and/or applications. The video processing core may receive such data and/or instructions for processing by the VPU 300.

At step 470, the video processing core and/or the VPU 300 may be operable to configure or combine the vector operations and their associated scalar operations, along with a set of scalar-only programs, for example, for the received data and/or instructions, into a set of two programs that may run independently in the VPU 300. A first program in the set, including data and/or instructions associated with the program's vector operations, associated scalar operations, and/or scalar-only operations, may be handled by the scalar core 330 and the vector core 380 in the VPU 300. A second program in the set, including data and/or instructions associated with the program's vector operations, associated scalar operations, and/or scalar-only operations, may be handled by the scalar core 340 and the vector core 380 in the VPU 300. By performing configuring the incoming data and/or instructions in this manner, the sharing of the vector core 380 by the scalar core 330 and the scalar core 340 is transparent to any existing or legacy software.

The set of programs described above may be achieved by, for example, mapping, converting, and/or translating certain of the received instructions, calls, functions, tasks, operations, and/or data into one or more instructions, calls, functions, tasks, operations, and/or data supported by the architecture of the VPU 300. The mapping, converting, translating, and/or other like operation may be performed in hardware, software, and/or a combination thereof in the video processing core and/or the VPU 300.

At step 480, the data and/or instructions associated with the first program may be processed the scalar core 330 and the vector core 380, while the data and/or instructions associated with the second program may be processed by the scalar core 340 and the vector core 380.

FIG. 5 is a flow chart that illustrates exemplary arbitration in the vector core, in accordance with an embodiment of the invention. Referring to FIG. 5, there is shown a flow chart 500 that describes an example of arbitration in the vector core 380. In step 510, instructions may be received at the vector core 380 from both the instruction dispatcher 310 and the instruction dispatcher 320. Vector instructions received from the instruction dispatcher 310 may be associated with a first image processing program. Vector instructions received from the instruction dispatcher 320 may be associated with the second image processing program.

In step 520, when there is a conflict in processing instructions for both the first and second image processing programs, the process may proceed to step 530. Conflicts may occur when, for example, there are resource constraints in the vector core 380. In step 530, the vector core 380 may be operable to perform arbitration to enable instructions from one of the first and second image processing programs to be executed. The arbitration may be based on an alternating scheme in which the image processing program that was denied access to resources in the vector core 380 during an immediately previous conflict is granted access during the current conflict. Such alternating scheme is maintained during operation, with the vector core 380 keeping track of which program was the last to be granted access to processing resources during a conflict. The arbitration scheme described above, however, is given by way of example and not of limitation. Other arbitration schemes may also be implemented to provide efficient resolution to conflicts that may occur between the first and second image processing programs in the vector core 380.

Returning to step 520, when there is no conflict, the process may proceed to step 540 in which instructions from both the first and second image processing programs may be concurrently executed by the vector core 380.

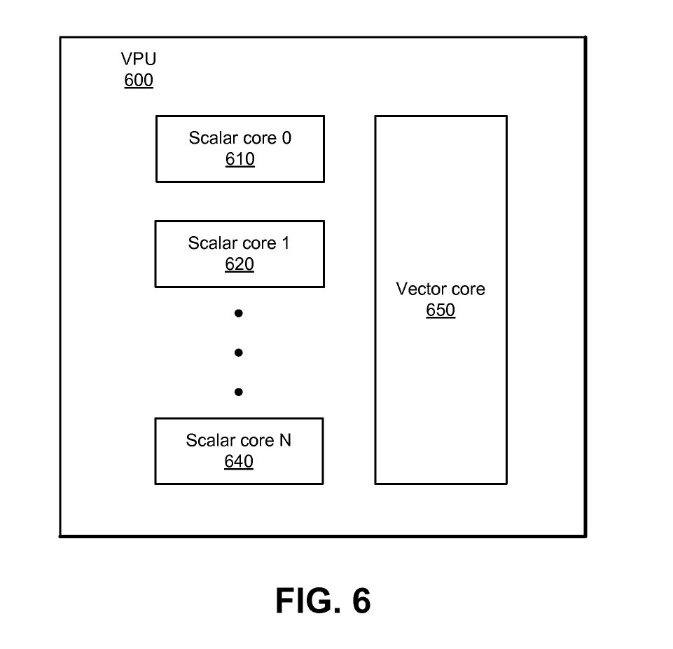

FIG. 6 is a block diagram of an exemplary video processing unit that is operable to provide video processing utilizing a plurality of scalar cores and a single vector core, in accordance with an embodiment of the invention. Referring to FIG. 6, there is shown a VPU 600 that may comprise N scalar cores 610, . . . , 640, where N is an integer number larger than 2, and a vector core 450. Each of the N scalar cores 610, . . . , 640 may be substantially similar to the scalar cores 330 and 340 described above. In this regard, each of the N scalar cores 610, . . . , 640 may comprise a scalar memory engine, a dual issue ALU, a scalar register file, and a multiplexer substantially similar to those described above in connection with the scalar cores 330 and 340. Moreover, although not shown in FIG. 6, each of the N scalar cores 610, . . . , 640 may share an instruction dispatcher with the vector core 650.

The vector core 650 may be substantially similar to the vector core 380 described above. In this regard, the vector core 650 may comprise a vector memory engine, a vector pipeline and repeat control module, a vector register file, a plurality of PPUs, and a scalar result module substantially similar to those described above in connection with the vector core 380.

In operation, each of the N scalar cores 610, . . . , 640 in the VPU 600 may process data and/or instructions associated with a corresponding image processing program, wherein each of the image processing programs is independent from the others. The vector core 650 may process data and/or instructions from one or more of the image processing programs. Each of the N scalar cores 610, . . . , 640 may receive instructions associated with its corresponding image processing program via an instruction stream that is shared with the vector core 650. During processing, the vector core 650 may obtain information from a register file in one or more of the N scalar cores 610, . . . , 640. The vector core 650 may also communicate results generated in the vector core 650 to a register file in one or more of the N scalar cores 610, . . . , 640. Moreover, the N scalar cores 610, . . . , 640 may provide information that may be utilized to access a different portion of a register file in the vector core 650.

When there is a conflict in processing instructions for more than one image processing program in the vector core 650, an arbitration operation may be performed by the vector core 650. The arbitration may be based on a scheme in which a determination as to which image processing program instruction to execute is based on a result from the last arbitration determination. In one embodiment of the invention, the arbitration scheme may be based on a determined order of priority that may be applied in accordance with the instructions and/or image processing programs being considered during the arbitration.

In an embodiment of the invention, a multimedia processor, such as the MMP 101a and the mobile multimedia processor 102 described above, may comprise a first scalar core, a second scalar core, and a vector core, such as the scalar core 330, the scalar core 340, and the vector core 380, respectively. The scalar core 330, the scalar core 340, and the vector core 380 may be integrated on a single substrate of the MMP 101a or of the mobile multimedia processor 102. In this regard, the scalar core 330, the scalar core 340, and the vector core 380 may be comprised in a vector processing unit, such as the VPU 300, in the multimedia processor. A method for processing image data utilizing a multimedia processor comprising the scalar core 330, the scalar core 340, and the vector core 380 may comprise processing, by the scalar core 330, one or both of data and instructions associated with a first image processing program. The scalar core 340 may process one or both of data and instructions associated with a second image processing program, wherein the second image processing program is independent from the first image processing program. The vector core 380 may process one or both of data and/or instructions associated with the first image processing program and data and/or instructions associated with the second image processing program.

The scalar core 330 and the vector core 380 may receive the instructions associated with the first image processing program via a single instruction stream. The scalar core 340 and the vector core 380 may receive the instructions associated with the second image processing program via a single instruction stream. The vector core 380 may receive one or more of an operand, an index, and an address offset from the scalar register file 336 in the scalar core 330. The vector core 380 may receive one or more of an operand, an index, and an address offset from the scalar register file 346 in the scalar core 340. Results generated by the vector core 380 may be communicated to the scalar register file 336 in the scalar core 330. Similarly, results generated by the vector core 380 may be communicated to the register file 346 in the scalar core 340. Based on information received from the scalar core 330, a first portion of the vector register file 386 in the vector core 380 may be accessed. Based on information received from the scalar core 40, a second portion of the vector register file 386 in the vector core 380 may be accessed, wherein the second portion of the vector register file 386 in the vector core 380 is different from the first portion of the vector register file 386 in the vector core 380.

The method for processing image data may comprise arbitrating the processing by the vector core 380. The arbitrating may be based on an alternating scheme, such as the one described above with respect to FIG. 5, for example.

In another embodiment of the invention, a multimedia processor, such as the MMP 101a and the mobile multimedia processor 102 described above, for example, may receive data and instructions associated with image processing. The MMP 101a or the mobile multimedia processor 102 may configure the received data and instructions into data and instructions associated with a first image processing program and into data and instructions associated with a second image processing program independent of the first image processing program. The data and instructions associated with the first image processing program may be configured by the MMP 101a or by the mobile multimedia processor 102 to be handled by a first scalar core, such as the scalar core 330, and by a vector core, such as the vector core 380. The data and instructions associated with the second image processing program may be configured by the MMP 101a or the mobile multimedia processor 102 to be handled by a second scalar core, such as the scalar core 340, and by a vector core, such as the vector core 380. In some instances, the received data and instructions may be initially configured to be handled by a processor comprising a single scalar core and a single vector core.

In other embodiments of the invention, when the MMP 101a or the mobile multimedia processor 102 support more than two scalar cores in connection with a single vector core, the MMP 101a or the mobile multimedia processor 102 may be operable to configure received data and instructions associated with image processing into more than two image processing programs. In such instances, each of the image processing programs may be handled by a corresponding scalar core and the single vector core.

Another embodiment of the invention may provide a non-transitory machine and/or computer readable storage and/or medium, having stored thereon, a machine code and/or a computer program having at least one code section executable by a machine and/or a computer, thereby causing the machine and/or computer to perform the steps as described herein for video processing utilizing a plurality of scalar cores and a single vector core.

Accordingly, the present invention may be realized in hardware, software, or a combination of hardware and software. The present invention may be realized in a centralized fashion in at least one computer system or in a distributed fashion where different elements may be spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing image data, the method comprising:
in a multimedia processor comprising a first scalar core, a second scalar core, and a vector core, wherein said first scalar core, said second scalar core, and said vector core are integrated on a single substrate of said multimedia processor:
receiving data and instructions associated with image processing; and
configuring said received data and instructions into data and instructions associated with a first image processing program and into data and instructions associated with a second image processing program independent of said first image processing program, wherein said data and instructions associated with said first image processing program are configured to be handled by said first scalar core and said vector core, and wherein said data and instructions associated with said second image processing program are configured to be handled by said second scalar core and said vector core.

2. The method according to claim 1, wherein said received data and instructions are initially configured to be handled by a processor comprising a single scalar core and a single vector core.

3. The method according to claim 1, comprising receiving, by said first scalar core and said vector core, said instructions associated with said first image processing program via a single instruction stream.

4. The method according to claim 1, comprising receiving, by said second scalar core and said vector core, said instructions associated with said second image processing program via a single instruction stream.

5. The method according to claim 1, comprising receiving, by said vector core, one or more of an operand, an index, and an address offset from a register file in said first scalar core.

6. The method according to claim 1, comprising receiving, by said vector core, one or more of an operand, an index, and an address offset from a register file in said second scalar core.

7. The method according to claim 1, comprising communicating results generated by said vector core to one or both of a register file in said first scalar core and a register file in said second scalar core.

8. The method according to claim 1, comprising arbitrating the handling, by said vector core, of said first image processing program and of said second image processing program.

9. The method according to claim 8, wherein said arbitrating is based on an alternating scheme.

10. The method according to claim 1, comprising:
accessing, based on information received from said first scalar core, a first portion of a register file in said vector core; and
accessing, based on information received from said second scalar core, a second portion of said register file in said vector core, wherein said second portion of said register file in said vector core is different from said first portion of said register file in said vector core.

11. A system for processing image data, the system comprising:
a multimedia processor comprising a first scalar core, a second scalar core, and a vector core, wherein said first scalar core, said second scalar core, and said vector core are integrated on a single substrate of said multimedia processor, wherein said multimedia processor is operable to:
receive data and instructions associated with image processing; and
configure said received data and instructions into data and instructions associated with a first image processing program and into data and instructions associated with a second image processing program independent of said first image processing program, wherein said data and instructions associated with said first image processing program are configured to be handled by said first scalar core and said vector core, and wherein said data and instructions associated with said second image processing program are configured to be handled by said second scalar core and said vector core.

12. The system according to claim 11, wherein said received data and instructions are initially configured to be handled by a processor comprising a single scalar core and a single vector core.

13. The system according to claim 11, wherein said first scalar core and said vector core are operable to receive said instructions associated with said first image processing program via a single instruction stream.

14. The system according to claim 11, wherein said second scalar core and said vector core are operable to receive said instructions associated with said second image processing program via a single instruction stream.

15. The system according to claim 11, wherein said vector core is operable to receive one or more of an operand, an index, and an address offset from a register file in said first scalar core.

16. The system according to claim 11, wherein said vector core is operable to receive one or more of an operand, an index, and an address offset from a register file in said second scalar core.

17. The system according to claim 11, wherein said vector core is operable to communicate results generated by said vector core to one or both of a register file in said first scalar core and a register file in said second scalar core.

18. The method according to claim 1, wherein said vector core is operable to arbitrate the handling of said first image processing program and of said second image processing program.

19. The system according to claim 18, wherein said arbitration is based on an alternating scheme.

20. The system according to claim 11, wherein:
said vector core is operable to access a first portion of register file in said vector core based on information received from said first scalar core; and
said vector core is operable to access a second portion of said register file in said vector core based on information received from said second scalar core, wherein said second portion of said register file in said vector core is different from said first portion of said register file in said vector core.
